(19) United States
(12) Patent Application Publication
(10) Pub. No.: US 2022/0106449 A1
(43) Pub. Date: Apr. 7, 2022

(54) FILM MADE OF RECYCLED PLASTIC MATERIAL FOR WEARABLE DATA STORAGE MEDIA, A PROCESS FOR PRODUCING THE RECYCLED FILM AND DATA STORAGE MEDIA CONTAINING THE RECYCLED FILM

(71) Applicant: GIESECKE+DEVRIENT MOBILE SECURITY GMBH, Munchen (DE)

(72) Inventor: Josef RIEDL, Attenkirchen (DE)

(21) Appl. No.: 17/429,521

(22) PCT Filed: Feb. 4, 2020
(86) PCT No.: PCT/EP2020/025048

§ 371 Date: Aug. 9, 2021

(30) Foreign Application Priority Data
Feb. 11, 2019 (DE) 10 2019 000 975.4

(51) Int. Cl. C08J 5/18; G06Q 50/04; G06Q 10/00

(52) U.S. Cl. CPC C08J 5/18; G06Q 50/04; G06Q 10/30; C08J 2323/06; G06K 19/02; C08J 2367/02; C08J 2379/08; C08J 2407/00; C08J 2475/04; C08J 2323/12

(57) ABSTRACT

A plastic foil suitable for manufacturing a data carrier includes at least one layer having a thermoplastic material recycled from mixed plastic waste. A method of manufacturing the plastic foil, to a data carrier with the plastic foil, and to a data carrier recyclate based on a polyolefin material, on a polyester material or on a polyamide material, are provided from mixed plastic waste.

The invention relates to a foil of recycled plastic material, which is suitable for manufacturing data carriers, to a method of manufacturing the foil, to a card body for a portable data carrier which includes the foil, to a recycled plastic material which is suitable for manufacturing the foil, and to a method of manufacturing this plastic material.

Worldwide, many millions of tonnes of plastic waste are produced every year. Only a small part of it, mostly production waste from industry, is clean and pure in type and can be recycled relatively easily and supplied back into the production process. The majority of plastic waste is a mixture of different plastic materials, often heavily soiled and mixed with non-plastic materials. Packaging materials such as foils, plastic bags and bottles play a large part in this. But also in household appliances, children's toys, in buildings and vehicles more and more plastic is used which will eventually become plastic waste. However, this mixture of materials is difficult to reclaim, which is why in the past decades, and in some cases still today, a large part of plastic waste ends up in landfills or is “disposed of” in nature. The plastic waste accumulates because plastic does not rot, at least not in manageable periods of time.

It goes without saying that it is desirable to avoid further accumulation of plastic waste and, if possible, also to reduce the already existing plastic waste mountains and to reclaim the plastic material (recycling).

The most useful way of reclaiming is the so-called “mechanical recycling”, in which a new plastic product is manufactured from plastic waste. A good cleaning, sorting and preparing of the plastic waste is important for a successful mechanical recycling. Methods for this are known. Large-format parts and metal parts are usually sorted out first and then the various plastics are separated as pure in type as possible. For this, one makes use of the different specific weights of the various types of plastic. In more recent methods, for recognizing the types of plastic there is also employed IR spectroscopy.

Substantially only thermoplastics are mechanically recycled. These can be melted down and formed into new products. In practice, these are mainly polyolefins (mainly polyethylene (PE) and polypropylene (PP), for example from foil materials), polyester (polyethylene terephthalate (PET), mainly from bottles), but also polyvinyl chloride (PVC), polystyrene (PS) and polyurethane (PU/PUR). Plastic waste from the sea also includes a significant portion of polyamides (PA), which mainly comes from fishing nets.

The thermoplastics, which are sorted out as pure in type as possible, are prepared, i.e. comminuted (ground material, agglomerate) and, where applicable, either remelted without admixtures and granulated, in which case a regranulate is obtained, or admixed with additives (compounding) during remelting and granulated for the purpose of improving the chemical, thermal, mechanical or other properties or setting the material properties according to the requirements of their subsequent use. Thereby a regenerate is obtained. Common admixture substances are for example stabilizers such as antioxidants, light stabilizers and flame retardants, colorants such as dyes and pigments, plasticizers, extenders, fillers and reinforcing materials.

Unfortunately, plastic materials obtained from used plastics do not have the same quality as the corresponding original plastic materials. On the one hand, this is due to the fact that a plastic waste's hundred percent pure-in-type separation is not feasible in practice. On the other hand, the plastic waste was often exposed to damaging environmental conditions over a longer period of time, which further deteriorates the quality of the material. This applies in particular to waste taken from landfills. This material is of particularly poor quality because it has been exposed to heat, cold and UV radiation.

The deterioration of the recycled plastics in terms of their mechanical and chemical properties and often also in terms of their thermal properties and optical properties compared to the corresponding “new” plastics cannot be completely compensated even by compounding with suitable additives. In fact, plastic products manufactured from recycled material therefore usually do not include 100% recycled plastic, but include only a certain portion of recycled plastic, the portion often being low. In general, it can be said that the higher the quality of the plastic product to be obtained or the more specific the requirements on the properties which a plastic product has to meet, the lower the tolerable portion of recycled material.

Packaging materials such as packaging foils, for example, tolerate a high portion of recycled material, while data carriers such as SIM cards, credit cards, health cards, ID cards and passport data pages, for example, could not yet be manufactured co-using recycled plastic.

Portable data carriers, for example electronic data carriers, comprise card bodies which consist of one or several plastic foils. Mostly, these are multilayer foils, such as coextruded composite foils. Common foil materials are thermoplastic polymers such as polyethylene terephthalate, polycarbonate, polyethylene, polypropylene, polyamides or thermoplastic polyurethanes. But monofoils are also used. These are mostly made of PVC.

The foil materials for card bodies have to meet high requirements. It is desirable that they
have a high degree of flexibility to ensure a high resistance to bending stresses of the data carrier,
have the ability to avoid tensions, cracks or breaks in the card bodies, in particular when the card body for manufacturing an electronic data carrier is combined with electronic components,
have a good temperature stability and dimensional stability during manufacture and processing,
have good handling during further processing, in particular do not tend to block,
are printable, can be sealed where applicable, and can also be laminated with other common card materials where applicable, and
are easy and inexpensive to manufacture.

In particular, the card body should tolerate the installation of electronic components without problems and comprise good resistance to stress cracks and breaks, for example upon bending stress and the action of impact force.

Plastics recovered from mixed plastic waste have not been able to meet these requirements so far.

It is desirable to find a way to produce plastic foils which have properties suitable for manufacturing portable data carriers such as chip cards from mixed plastic waste of any undefined origin.

It is therefore an object of the present invention to provide a plastic material which includes recycled plastic and is suitable for manufacturing foils for card bodies of portable data carriers, and to provide a method of manufacturing the plastic material from mixed plastic waste of undefined origin.

It is also an object of the present invention to provide a foil which includes plastic material recycled from mixed plastic waste of undefined origin and is suitable for manufacturing data carrier card bodies, and to provide a method of manufacturing the foil.

It is further an object of the present invention to provide a data carrier or a card body for a data carrier which comprises a foil which includes plastic material recycled from mixed plastic waste of undefined origin.

Data carriers within the meaning of the present invention are portable items which comprise a card body which comprises at least one plastic foil. By equipping it with data or elements including data, for example with imprints or electronic modules, from the card body there is manufactured an (electronic) data carrier. Example data carriers are SIM cards, credit cards, health cards or identity cards such as national ID cards.

The objects are achieved by the method of manufacturing a plastic material having the features as stated in independent claim 1, by the plastic material having the features as stated in independent claim 2, by the foil having the features as stated in independent claim 5, by the method of manufacturing the foil having the features as stated in independent claim 10, and by the data carrier having the features as stated in independent claim 13. Embodiments of the invention are stated in the respective dependent claims.

The present invention is based on the findings that polyolefins, polyesters and polyamides which have been recycled from mixed plastic waste can be modified by admixing particular thermoplastic elastomers such that they are suitable for manufacturing foils for data carrier card bodies. This is possible even if the polyolefins, polyesters or polyamides were obtained from plastic waste. The starting materials for modified polyolefins, polyesters and polyamides are the corresponding thermoplastics which were recovered as pure in type as possible in a known manner from mixed plastic waste.

The term “pure in type” as used herein means that the recycled plastics, while matching in their basic polymers, may include different additives (such as flame retardants, antioxidants, etc.). In the technical field of plastics recycling, the term “of a similar type” is also commonly used for these plastics.

Furthermore, for the purposes of the present disclosure, a particular polyolefin (for example polyethylene), a particular polyester (for example polyethylene terephthalate) and a particular polyamide is also considered to be “pure in type” if it includes a particular portion of other plastics with which it is homogeneously mixable in the melt. The portion of such plastics should preferably be at most 10 wt %, particularly preferably at most 5 wt %. A small portion of contamination, i.e. of plastics that are not homogeneously mixable with the thermoplastic polyolefin, polyester or polyamide in the melt, is also tolerable. However, it should not be more than 1 wt. %, preferably not more than 0.5 wt %, and ideally 0 wt %.

The starting materials are preferably employed in the form of regenerate, i.e. they are already compounded with additives (chain extenders, impact modifiers, etc.) as they are commonly used to adapt the recycled material to its later use as foil material. However, the starting materials can also be employed in the form of ground material, agglomerates or regranulates.

In the following, the starting material, regardless of whether it is ground material, agglomerates, regranulate or regenerate, is referred to by the term “recyclate”.

In order to obtain a plastic material which is suitable for manufacturing foils for card bodies of portable data carriers, the recyclate is modified according to the invention with thermoplastic elastomers.

The thermoplastic elastomers are block copolymers with hard and soft segments. The hard segments act as physical cross-linking points and impart strength to the thermoplastic elastomer, while the soft segments impart flexibility to the thermoplastic elastomer. By varying the portion of hard segments and soft segments, the properties of the thermoplastic elastomer can be varied within broad limits.

The kind of thermoplastic elastomer used for modification must be coordinated to the kind of recyclate to be modified:

For modifying polyolefin recyclates (for example polyethylene recyclates), thermoplastic olefin elastomers or thermoplastic rubber vulcanizates are employed. Thermoplastic rubber vulcanizates or thermoplastic polyolefin vulcanizates are a mixture of a polyolefin-based plastic, especially polypropylene (hard segment), and a monomer such as ethylene-propylene-diene monomer (soft segment).

For the modification of polyester recyclates (for example PET recyclates), thermoplastic copolyester elastomers are preferably used, for example with a butylene terephthalate block (hard segment) and a butylene glycol ether block (soft segment). However, thermoplastic urethane elastomers, for example elastomers with a polyurethane block (hard segment) and a polyester block (soft segment) are also suitable.

For the modification of polyamide recyclates, thermoplastic polyamide elastomers are preferably employed, for example elastomers with a polyamide block (hard segment) and a polyether block (soft segment). However, thermoplastic copolyester elastomers and thermoplastic urethane elastomers as described above for polyester recyclates are also suitable.

When choosing suitable thermoplastic elastomers, it must be taken into account that they should have a melt viscosity as similar as possible to the melt viscosity of the recyclate to be modified. At the same time, the thermoplastic elastomer should have a lowest possible Shore hardness and the best possible elongation at break value. The Shore hardness of PEBA (polyether block amide) should be in a range of 20-50, preferably in a range of 30-45 Shore hardness D. The Shore hardness of TPU should be in a range of 15-70, preferably in a range of 30-65 Shore hardness D. The Shore hardness of TPC (thermoplastic copolyester elastomers) should be in a range of 32-73, preferably in a range of 45-71 Shore hardness D. The Shore hardness for TPO/TPV (thermoplastic olefin elastomers/thermoplastic rubber vulcanizates) should be in a range of 10-41, preferably in a range of 22-35 Shore hardness D. Suitable ranges for elongation at break are 200%-700%, preferably 350% to 700%. In case of a comparable match regarding the melt viscosities, the thermoplastic elastomer with the lowest Shore hardness and/or the best elongation at break value is to be selected.

The amounts of thermoplastic elastomers used for modification depend on the recyclate material as well as on the layer of a data carrier recycling foil (of a foil suitable for manufacturing a data carrier) for which the data carrier recyclate (the recyclate modified with thermoplastic elastomer) is intended. Foils for manufacturing data carriers can be single-layer or multilayer. Usually, multilayer composite foils are preferred.

In the case of multilayer foils, data carrier recyclates with a higher portion of recyclate are preferably used for layers located further inward rather than for layers located further outward, i.e. the portion of thermoplastic elastomer is the higher the further outward the respective layer is located in the foil composite. Outer layers of pure thermoplastic elastomer or of a sealable thermoplastic without recyclate portion can also be used.

However, it is also possible that in multilayer foils the layers located further outward include more recyclate than the inner layers.

Preferred weight ratios of recyclate material and modifying thermoplastic elastomer are for polyester recyclates 2.5-15 wt %, and possibly up to 20 wt % thermoplastic elastomer, particularly preferably 5-7 wt % thermoplastic elastomer in the data carrier recyclate; for polyolefin recyclates 2.5-20 wt % thermoplastic elastomer, particularly preferably 5-10 wt % thermoplastic elastomer in the data carrier recyclate; and for polyamide recyclates 2.5-20 wt % thermoplastic elastomer, particularly preferably 5-10 wt % thermoplastic elastomer in the data carrier recyclate.

The processing of the data carrier recyclate (the recyclate modified with thermoplastic elastomer) into a data carrier recycling foil (a foil made from the data carrier recyclate which is suitable for manufacturing a data carrier or a data carrier card body) can be effected in a manner known per se by blow moulding, whereby a tubular foil is produced. Alternatively, flat foils can be manufactured. In any case, the data carrier recyclate is supplied to an extruder, for example as a granular material, liquefied into a polymer melt and extruded through a nozzle.

For multilayer foils with different recyclate portions, several extruders are needed, corresponding to the amount of different feed materials. A foil with three layers of different composition requires three extruders, as does a foil with five layers where respectively two layers have an identical composition. The data carrier recyclates melted in the extruders form streams of melt that are combined in a multilayer ring nozzle (in the case of blow moulding) into a composite foil, or (in the case of coextruded flat foils) are brought together upstream of the nozzle via an adapter and extruded together through a wide slot nozzle. The still liquid prefilm formed thereby is then cooled down and solidified, for example by placing it against a casting roll.

Instead of feeding the extruder(s) with “finished” data carrier recyclate, the data carrier recyclate can also be manufactured in the extruder(s) from regenerate and thermoplastic elastomer by feeding the extruder(s) with regenerate and thermoplastic elastomer in the respectively desired amounts.

Feeding with regranulate, additives and thermoplastic elastomer, i.e. compounding the regranulate with additives into the regenerate and modifying the regenerate into the data carrier recyclate in the same extruder is also possible in principle, but less preferred. Rather, the compounding of the recovered plastic material with the usual additives, as they are also added to newly manufactured plastics for improving the properties, is preferably effected separately before the modification, for example in a mixing system, a kneading system or a compounding extruder.

Coextruded composite foils are preferred over monolayer foils. Coextrusion allows to connect plastic materials that are only compatible with each other to a limited extent. Thin outer layers (5-10 μm) can be set in a defined manner so that the composite foils are laminable and printable as well as chemically resistant and ageing resistant. Inner layers can be set to impart properties such as high flexibility, high resistance to bending stresses and impact resistance to the card body, independently of properties such as lamination properties and printing properties. For opaque inner layers, the color can also be set in a defined manner. Intermediate layers between inner and outer layers additionally increase the degree of freedom in the composition of the foil formulations, and thus also the degree of freedom in achieving desired foil properties.

When manufacturing the data carrier recycling foils according to the invention, usual process parameters are used for the materials used, which are known to a person skilled in the art.

The finished data carrier recycling foils cut to the desired size can be used as data carrier card bodies. They can also be laminated with other foils and thus represent only a partial layer of a card body.

For manufacturing data carriers, the card bodies are equipped with imprints, security elements and/or electronic modules in a manner known to a person skilled in the art.

The present invention will hereinafter be illustrated further with reference to figures. It is pointed out that in the present invention disclosure relating to a subject matter of the invention, such as data carrier recyclate, method of producing a data carrier recyclate, data carrier recycling foil, method of producing a data carrier recycling foil as well as data carriers, applies in an analogous manner to the respective other subject matters of this invention. It is further pointed out that the figures are not true scale and not true to proportion. They are merely intended to explain the invention in more detail and are in no way to be understood in a restrictive way. Identical reference signs respectively designate identical elements.

There are shown:

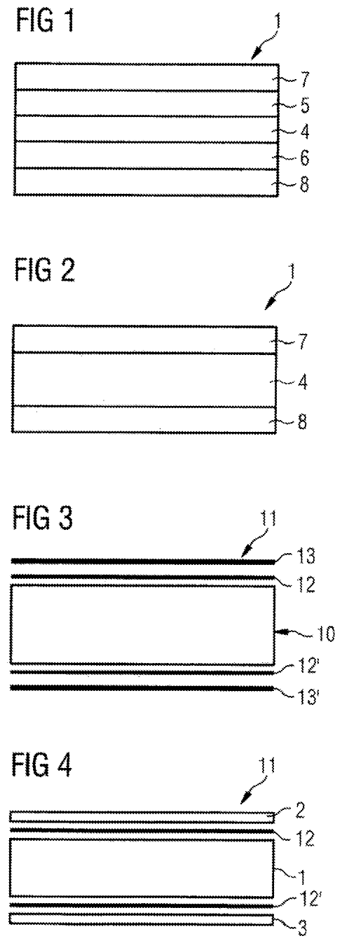

FIG. 1 a section through a data carrier recycling foil having five layers according to the invention,

FIG. 2 a section through a data carrier recycling foil having three layers according to the invention,

FIG. 3 a section through a data carrier having a monofoil structure according to the invention,

FIG. 4 a section through a data carrier having a multilayer structure according to the invention, and

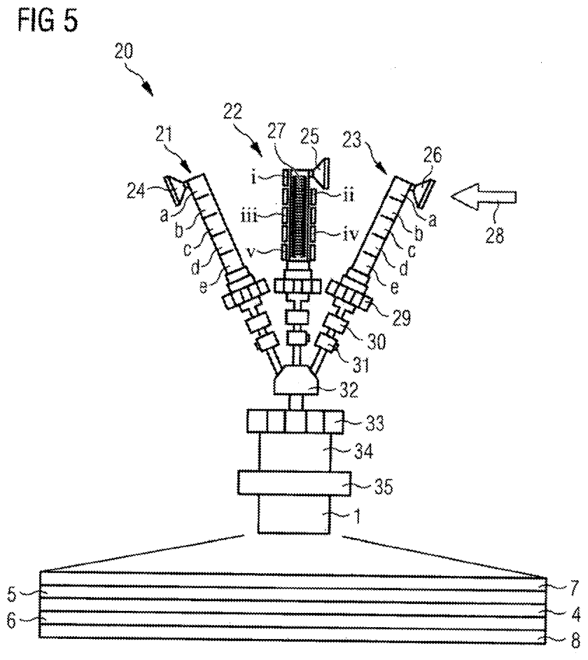

FIG. 5 a schematic representation of a manufacturing method of a data carrier recycling foil according to the invention, as shown in FIG. 1.

FIG. 1 shows a first embodiment of a data carrier recycling foil 1 according to the invention in cross section. The represented data carrier recycling foil is a composite foil having an inner layer 4, a first outer layer 7, a second outer layer 8, a first intermediate layer 5 and a second intermediate layer 6. In FIG. 1 all the layers comprise the same thickness, but the layers can also have different thicknesses, in the case of different thicknesses the inner layer being preferably the thickest layer.

The data carrier recycling foil 1 may comprise an inner layer 4 and intermediate layers 5, 6 which include recycled polyethylene terephthalate. In the represented embodiment, the inner layer 4 includes 95 wt % of PET recyclate and 5 wt % of copolyester elastomer, the intermediate layers 5, 6 each include 90 wt % of PET recyclate and 10 wt % of the same copolyester elastomer, and the outer layers 7, 8 each consist of the pure copolyester elastomer. Alternatively, recyclates other than PET can of course also be used.

Such a composite foil can be manufactured as schematically illustrated in FIG. 5.

FIG. 5 shows a device 20 having extruders 21, 22, 23, an adapter 32, a wide slot nozzle 33 and a casting roll 35. Each of the extruders 21, 22, 23 has five zones a, b, c, d and e in which different temperatures can be set by means of heating devices i, ii, iii, iv and v (represented for extruder 22). Feed hoppers 24, 25, 26 supply the respective feed material to the extruders 21, 22, 23. The feed material is represented schematically as arrow 28 at extruder 23. Reference sign 29 designates an optional mixing part, reference signs 30, 31 designate flanges.

In the case of the composite foil 1 represented in FIG. 1, a feed material of 95 wt % PET recyclate and 5 wt % thermoplastic elastomer is supplied to the extruder 22 for manufacturing the inner layer 4, while a feed material of 90 wt % PET recyclate and 10 wt % thermoplastic elastomer is supplied to extruder 21 for manufacturing the intermediate layers 5, 6, and a feed material of pure thermoplastic elastomer is supplied to the extruder 23 for manufacturing the outer layers 7, 8. In the extruders, the feed material is melted and transported through the extruder zones a, b, c, d and e by means of screws (for extruder 22 schematically represented as screw 27). Suitable temperatures for the individual zones are represented in Table 1.

TABLE 1
(PET)

| Extruder | | | |
|---|---|---|---|
| Zone | 21 | 22 | 23 |
| a | 85° C. | 85° C. | 85° C. |
| b | 265° C. | 265° C. | 265° C. |
| c | 270° C. | 270° C. | 270° C. |
| d | 270° C. | 270° C. | 270° C. |
| e | 270° C. | 270° C. | 270° C. |
| Adapter | 280° C. | 280° C. | 280° C. |
| Nozzle | 275° C. | 275° C. | 275° C. |

The process parameters vary in dependence on the feed material. Suitable temperatures for a polyolefin recyclate (for example a polyethylene recyclate) are stated in Table 2 and suitable temperatures for a polyamide recyclate are stated in Table 3. It is to be understood that the values represent exemplary guide values in each case. Starting out from these guide values, the optimum temperatures for a specific feed material can be ascertained by a person skilled in the art with a few tests.

TABLE 2
(PE)

| Extruder | | | |
|---|---|---|---|
| Zone | 21 | 22 | 23 |
| a | 60° C. | 60° C. | 60° C. |
| b | 225° C. | 225° C. | 225° C. |
| c | 230° C. | 230° C. | 230° C. |
| d | 235° C. | 235° C. | 235° C. |
| e | 235° C. | 235° C. | 235° C. |
| Adapter | 235° C. | 235° C. | 235° C. |
| Nozzle | 235° C. | 235° C. | 235° C. |

TABLE 3
(PA6.6)

| Extruder | | | |
|---|---|---|---|
| Zone | 21 | 22 | 23 |
| a | 85° C. | 85° C. | 85° C. |
| b | 255° C. | 255° C. | 255° C. |
| c | 260° C. | 260° C. | 260° C. |
| d | 260° C. | 265° C. | 260° C. |
| e | 260° C. | 265° C. | 260° C. |
| Adapter | 265° C. | 265° C. | 265° C. |
| Nozzle | 260° C. | 260° C. | 260° C. |

The streams of melt of the extruders 21, 22, 23 are brought together in the adapter 32 and extruded together through the wide slot nozzle 33, for example a coat hanger nozzle, thereby the prefilm 34 being formed. The still liquid prefilm is cooled down and solidified by placing it against the casting roll 35, thereby obtaining the data carrier recycling foil 1, which is represented enlarged in a sectional view below the device 20.

Instead of using polyester recyclate for the inner layer 4 and the intermediate layers 5, 6 respectively, different recyclates could also be used, for example a polyethylene terephthalate recyclate for the inner layer 4 and a polyethylene recyclate for the intermediate layers 5, 6. In an analogous manner, for modifying the recyclates there can also be used different thermoplastic elastomers, in the case of a polyester recyclate for example a copolyester elastomer in the inner layer 4 and a urethane elastomer in the intermediate layers 5, 6.

Likewise, the different layers of a data carrier recycling foil configured as a composite foil may include different additives in different amounts. For example, the outer layers 7, 8 could include antioxidants, light stabilizers and flame retardants, while the inner layer 4 could include admixtures for improving the impact strength as well as pigments for coloring and/or opacification.

The innermost layer does not necessarily have to be the layer with the highest recyclate portion. For example, in the embodiment according to FIG. 1, the inner layer 4 of the data carrier recycling foil 1 could include 90 wt % PET recyclate and 10 wt % copolyester elastomer, while the intermediate layers 5, 6 could each include 95 wt. % PET recyclate and 5 wt % copolyester elastomer, and the outer layers 7, 8 could consist of thermoplastic original (i.e. without admixture of used material) copolyester.

FIG. 2 shows another embodiment of a data carrier recycling foil 1 according to the invention. This embodiment likewise is a composite foil, but a composite foil with only three layers, an inner layer 4, a first outer layer 7 on one side of the inner layer 4, and an outer layer 8 on the other side of the inner layer 4. In the embodiment represented in FIG. 2, the outer layers 7, 8 have the same thickness, but are configured thinner than the inner layer 4.

Such a foil can be coextruded by means of a device which is similar to the device 20 of FIG. 5, however, only two extruders will be needed, if the two outer layers 7, 8 have the same composition. For outer layers 7, 8 having different compositions, again three extruders are needed.

A data carrier recycling foil 1 having the layer structure represented in FIG. 2 could have an inner layer 4 of 95 wt % recyclate (polyester, polyolefin or polyamide), and outer layers 7, 8 each of 80 wt % recyclate and 20 wt % thermoplastic elastomer. Alternatively, the outer layers 7, 8 could consist of a sealable thermoplastic, for example. In the case of an inner layer based on PET recyclate, the outer layers could consist of PETG (PET modified with glycol).

If very specific properties are desired for a particular surface of a data carrier recycling foil, for example sealability or particularly good printability, it may be necessary to keep the recyclate portion in the relevant layer low or to configure the relevant layer without recyclate. In such a case, it is preferred to configure the recyclate-free layer as thin as possible, for example with a thickness of 5-10 μm.

According to further embodiments of the invention (not shown), the data carrier recycling foils may also be composite foils having an even number of layers, for example with 2, 4 or 6 layers. For example, a data carrier recycling foil having two layers could have a layer of 95 wt % recyclate and 5 wt % thermoplastic elastomer, which makes up 80% of the thickness of the data carrier recycling foil, and a layer of thermoplastic elastomer which makes up 20% of the thickness of the data carrier recycling foil. Such a data carrier recycling foil is manufacturable with the help of two extruders whose streams of melt are brought together in a suitable adapter.

FIG. 3 shows a data carrier 11 according to the invention with a monofoil structure, such as a SIM card. The data carrier 11 has a card body 10 which is formed by a single-layer data carrier recycling foil. In an exemplary embodiment, the single-layer data carrier recycling foil has a composition of 95 wt % recyclate and 5 wt % thermoplastic elastomer. Preferably, this recycling foil has an opacifying agent. Both surfaces of the card body 10 and of the data carrier recycling foil comprise design print layers 12 and 12′, which in turn each have a lacquering 13, 13′.

FIG. 4 shows an alternative embodiment of a data carrier 11 according to the invention, for example a credit card, with a multilayer structure. The data carrier 11 of the embodiment shown in FIG. 4 has a core layer of a data carrier recycling foil 1 which is similar to the card body 10 of the data carrier 11 represented in FIG. 3. On both surfaces of the data carrier recycling foil 1 there are design print layers 12 and 12′ respectively, which in turn are covered by data carrier recycling foils 2, 3. The data carrier recycling foils 2, 3 have a lower portion of recyclate than the data carrier recycling foil 1, for example 70 wt % recyclate, and are transparent.

The recycling foil according to the invention and the data carriers manufactured from the recycling foil according to the invention can be manufactured in an environmentally friendly and cost-effective manner. They have no disadvantages compared to foils or data carriers which are manufactured of plastic materials without recycling portion.

Advantageous embodiments of the invention are stated below:

1. A method of producing a thermoplastic material based on a polyolefin, a polyester or a polyamide from mixed plastic waste, wherein the plastic material is suitable for manufacturing a plastic foil for a data carrier, comprising
(a) providing a polyolefin material, a polyester material or a polyamide material, which was separated as pure in type as possible from mixed plastic waste,
(b) compounding the polyolefin material, the polyester material or the polyamide material with additives for improving the chemical and/or mechanical and/or optical properties in order to obtain a polyolefin regenerate, a polyester regenerate or a polyamide regenerate which is suitable for manufacturing a plastic foil; and

### (c) Modifying

the polyolefin material with a thermoplastic olefin elastomer and/or a thermoplastic rubber vulcanizate, or
the polyester material with a thermoplastic copolyester elastomer and/or a thermoplastic urethane elastomer, or
the polyamide material with a thermoplastic polyamide elastomer and/or a thermoplastic copolyester elastomer and/or a thermoplastic urethane elastomer,
in order to obtain a data carrier recyclate based on a polyolefin, on a polyester or on a polyamide, wherein the data carrier recyclate is suitable for manufacturing a plastic foil for a data carrier.
2. A data carrier recyclate based on a thermoplastic polyolefin material, on a thermoplastic polyester material or on a thermoplastic polyamide material, which was separated as pure in type as possible from mixed plastic waste, wherein the data carrier recyclate includes additives for improving the chemical and/or mechanical and/or optical properties and at least one modifying agent which makes it suitable for manufacturing a plastic foil for a data carrier, wherein the modifying agent
in the case of a polyolefin material, is a thermoplastic olefin elastomer and/or a thermoplastic rubber vulcanizate,
in the case of a polyester material, is a thermoplastic copolyester elastomer and/or a thermoplastic urethane elastomer, and
in the case of a polyamide material, is a thermoplastic polyamide elastomer and/or a thermoplastic copolyester elastomer and/or a thermoplastic urethane elastomer.
3. The data carrier recyclate according to embodiment 2 or the method according to embodiment 1, wherein
the thermoplastic olefin elastomer and/or the thermoplastic rubber vulcanizate is a block copolymer with a polyolefin-based polymer as hard segment and an ethylene-propylene-diene monomer as soft segment,
the thermoplastic copolyester elastomer is a block copolymer with a butylene terephthalate block as hard segment and a butylene glycol ether block as soft segment,
the thermoplastic urethane elastomer is a block copolymer with a polyurethane block as hard segment and a polyester block as soft segment, and
the thermoplastic polyamide elastomer is a block copolymer with a polyamide block as hard segment and a polyether block as soft segment.
4. The data carrier recyclate according to embodiment 2 or 3 or the method according to embodiment 1 or 3, wherein the data carrier recyclate includes
in the case of a polyolefin material, 2.5-20 wt %, preferably 5-10 wt %, thermoplastic olefin elastomer and/or thermoplastic rubber vulcanizate,
in the case of a polyamide material, 2.5-20 wt %, preferably 5-10 wt %, thermoplastic polyamide elastomer and/or copolyester elastomer and/or urethane elastomer, and
in the case of a polyester material, 2.5-15 wt %, preferably 5-7 wt %, of thermoplastic copolyester elastomer and/or thermoplastic urethane elastomer.
5. The data carrier recyclate according to any of embodiments 2 to 4 or the method according to embodiment 1, 3 or 4, wherein the data carrier recyclate includes at least one additive which is selected from the group consisting of chain extenders, impact modifiers, antioxidants, light stabilizers, colorants and fillers.
6. The data carrier recyclate according to any of embodiments 2 to 5 or the method according to any of embodiments 1 and 3-5, wherein the polyolefin material is polyethylene or the polyester material is polyethylene terephthalate.
7. A plastic foil which is suitable for manufacturing a data carrier and comprises at least one layer which includes a thermoplastic material which was recycled from mixed plastic waste, wherein the at least one layer comprises a data carrier recyclate according to any of embodiments 2 to 6.
8. The plastic foil according to embodiment 7, wherein the foil is a multilayer composite foil having an inner layer and at least two further layers, and wherein at least the inner layer includes a data carrier recyclate according to any of embodiments 2 to 6.
9. The plastic foil according to embodiment 7 or 8, wherein the foil is a multilayer composite foil having an inner layer, two outer layers and at least one intermediate layer respectively between the inner layer and one of the outer layers, and wherein at least the inner layer and the intermediate layers include a data carrier recyclate according to any of embodiments 2 to 6.
10. The plastic foil according to embodiment 8 or 9, wherein in each layer which includes a data carrier recyclate, the portion of recyclate is the higher the further inward in the layer composite the layer is located.
11. The plastic foil according to any of embodiments 8 to 10, wherein at least one outer layer does not include recyclate.
12. The plastic foil according to embodiment 11, wherein at least one outer layer consists of a thermoplastic elastomer or of a sealable thermoplastic material such as a glycol-modified polyethylene terephthalate.
13. The plastic foil according to any of embodiments 8 to 12, wherein the inner layer includes 90-98 wt. % recyclate and the outer layers, independently of each other, include 0-70 wt. % recyclate.
14. The plastic foil according to embodiment 13, with respectively one intermediate layer between the inner layer and each of the outer layers, wherein the intermediate layers, independently of each other, include 80-95 wt. % recyclate.
15. The plastic foil according to embodiment 7, which consists of one single layer with a portion of recyclate of 50-95 wt %.
16. The plastic foil according to embodiment 7, wherein the foil is a composite foil having at least two layers and wherein at least one of the layers includes a data carrier recyclate according to any of embodiments 2 to 6.
17. The plastic foil according to any of embodiments 8 to 14, which comprises five layers, wherein the thickness of the inner layer constitutes 20-80% of the total thickness of the foil, the thicknesses of the intermediate layers respectively constitute 5-20 wt % of the total thickness of the foil, and the thickness of the outer layers respectively constitute 5-20% of the total thickness of the foil.
18. The plastic foil according to any of embodiments 7 to 17, wherein the total thickness of the foil is 50 μm to 800 μm.
19. The plastic foil according to any of embodiments 7 to 18, wherein at least one foil layer is opaque and the remaining foil layers are transparent, and wherein in a multilayer foil at least one outer layer is transparent.
20. A method of manufacturing a plastic foil which is suitable for manufacturing a data carrier and comprises at least one layer which includes a thermoplastic material which was recycled from mixed plastic waste,
comprising the following steps:
feeding at least one extruder with
a data carrier recyclate according to any of embodiments 2 to 6, or
a material forming a data carrier recyclate according to any of embodiments 2 to 6, which comprises a polyolefin regenerate or a polyester regenerate or a polyamide regenerate, which was obtained by carrying out the steps (a) and (b) according to embodiment 1, and a modifying agent, wherein the modifying agent
in the case of a polyolefin material, is a thermoplastic olefin elastomer and/or a thermoplastic rubber vulcanizate,
in the case of a polyester material, is a thermoplastic copolyester elastomer and/or a thermoplastic urethane elastomer, and
in the case of a polyamide material, is a thermoplastic polyamide elastomer and/or a thermoplastic copolyester elastomer and/or a thermoplastic urethane elastomer, and
   extruding the data carrier recyclate in order to obtain a data carrier recycling foil.
   21. The method according to embodiment 20, wherein a multilayer composite foil having an inner layer and at least two further layers is produced, in which at least the inner layer includes a data carrier recyclate according to any of embodiments 2 to 6, comprising the following steps:
   feeding at least the extruder producing the inner layer with a data carrier recyclate according to any of embodiments 2 to 6 or a material forming a data carrier recyclate according to any of embodiments 2 to 6,
   feeding one or several further extruders with a data carrier recyclate according to any of embodiments 2 to 6 or with a material forming a data carrier recyclate according to any of embodiments 2 to 6 or with a plastic material that does not include recycled plastic material,
   coextruding the inner layer and the at least two further layers and thereby producing a composite foil.
   22. The method according to embodiment 20 or 21, wherein two further extruders are used and wherein one of the extruders is fed with a data carrier recyclate according to any of embodiments 2 to 6 or a material forming a data carrier recyclate according to any of embodiments 2 to 6, and the other extruder is fed with a plastic material that does not include recycled plastic material.
   23. The method according to any of embodiments 20 to 22, wherein a composite foil having several layers which include a data carrier recyclate according to any of embodiments 2 to 6 is produced, and wherein in each layer which includes a data carrier recyclate the portion of recyclate is the higher the further inward in the layer composite of the composite foil the layer is located.
   24. A data carrier comprising a card body which comprises at least one data carrier recycling foil according to any of embodiments 7 to 19.
   25. The data carrier according to embodiment 24, further comprising at least one electronic module and/or one imprint.
   26. The data carrier according to embodiment 24 or 25, comprising an opaque data carrier recycling foil, a design print layer on each of the two main areas of the data carrier recycling foil, and a lacquering on the design print layers.
   27. The data carrier according to embodiment 24 or 25, comprising an opaque data carrier recycling foil, a design print layer on each of the two main areas of the data carrier recycling foil, and respectively one transparent data carrier recycling foil covering the design print layers.
   28. The data carrier according to any of embodiments 24 to 27, wherein the data carrier is a SIM card, a credit card or an ID card.

1.-15. (canceled)

16. A method of producing a thermoplastic material based on a polyolefin, a polyester or a polyamide from mixed plastic waste,
wherein the plastic material is suitable for manufacturing a plastic foil for a data carrier, comprising
(a) providing a polyolefin material, a polyester material or a polyamide material, which was separated as pure in type as possible from mixed plastic waste,
(b) compounding the polyolefin material, the polyester material or the polyamide material with additives for improving the chemical and/or mechanical and/or optical properties in order to obtain a polyolefin regenerate, a polyester regenerate or a polyamide regenerate which is suitable for manufacturing a plastic foil; and
(c) modifying
the polyolefin material with a thermoplastic olefin elastomer and/or a thermoplastic rubber vulcanizate, or
the polyester material with a thermoplastic copolyester elastomer and/or a thermoplastic urethane elastomer, or
the polyamide material with a thermoplastic polyamide elastomer and/or a thermoplastic copolyester elastomer and/or a thermoplastic urethane elastomer,
in order to obtain a data carrier recyclate based on a polyolefin, on a polyester or on a polyamide, wherein the data carrier recyclate is suitable for manufacturing a plastic foil for a data carrier.

17. A data carrier recyclate based on a thermoplastic polyolefin material, on a thermoplastic polyester material or on a thermoplastic polyamide material, which was separated as pure in type as possible from mixed plastic waste,
wherein the data carrier recyclate includes additives for improving the chemical and/or mechanical and/or optical properties and at least one modifying agent which makes it suitable for manufacturing a plastic foil for a data carrier,
wherein the modifying agent
in the case of a polyolefin material, is a thermoplastic olefin elastomer and/or a thermoplastic rubber vulcanizate,
in the case of a polyester material, is a thermoplastic copolyester elastomer and/or a thermoplastic urethane elastomer, and
in the case of a polyamide material, is a thermoplastic polyamide elastomer and/or a thermoplastic copolyester elastomer and/or a thermoplastic urethane elastomer.

18. The data carrier recyclate according to claim 17, wherein
the thermoplastic olefin elastomer and/or the thermoplastic rubber vulcanizate is a block copolymer with a polyolefin-based polymer as hard segment and an ethylene-propylene-diene monomer as soft segment,
the thermoplastic copolyester elastomer is a block copolymer with a butylene terephthalate block as hard segment and a butylene glycol ether block as soft segment, the thermoplastic urethane elastomer is a block copolymer with a polyurethane block as hard segment and a polyester block as soft segment, and
the thermoplastic polyamide elastomer is a block copolymer with a polyamide block as hard segment and a polyether block as soft segment.

19. The data carrier recyclate according to claim 17, wherein the data carrier recyclate includes in the case of a polyolefin material, 2.5-20 wt %, preferably 5-10 wt %, thermoplastic olefin elastomer and/or thermoplastic rubber vulcanizate,
in the case of a polyamide material, 2.5-20 wt %, preferably 5-10 wt %, thermoplastic polyamide elastomer and/or copolyester elastomer and/or urethane elastomer, and
in the case of a polyester material, 2.5-15 wt %, preferably 5-7 wt %, of thermoplastic copolyester elastomer and/or thermoplastic urethane elastomer.

20. A plastic foil which is suitable for manufacturing a data carrier and comprises at least one layer which includes a thermoplastic material which was recycled from mixed plastic waste,
wherein the at least one layer comprises a data carrier recyclate according to claim 17.

21. The plastic foil according to claim 20, wherein the foil is a multilayer composite foil having an inner layer and at least two further layers, and
wherein at least the inner layer includes a data carrier recyclate.

22. The plastic foil according to claim 21, wherein in each layer which includes a data carrier recyclate the portion of recyclate is the higher the further inward in the layer composite the layer is located.

23. The plastic foil according to claim 21, wherein the inner layer includes 90-98 wt. % recyclate and the outer layers, independently of each other, include 0-70 wt. % recyclate.

24. The plastic foil according claim 20, which consists of one single layer with a portion of recyclate of 50-95 wt %.

25. A method of manufacturing a plastic foil which is suitable for manufacturing a data carrier and comprises at least one layer which includes a thermoplastic material which was recycled from mixed plastic waste,
comprising the following steps:
feeding at least one extruder with
a data carrier recyclate according to claim 17, or
a material forming a data carrier recyclate according to claim 17, which comprises a polyolefin regenerate or a polyester regenerate or a polyamide regenerate, which was obtained by carrying out the steps of providing a polyolefin material, a polyester material or a polyamide material, which was separated as pure in type as possible from mixed plastic waste, and compounding the polyolefin material, the polyester material or the polyamide material with additives for improving the chemical and/or mechanical and/or optical properties in order to obtain a polyolefin regenerate, a polyester regenerate or a polyamide regenerate which is suitable for manufacturing a plastic foil; and
a modifying agent, wherein the modifying agent
in the case of a polyolefin material, is a thermoplastic olefin elastomer and/or a thermoplastic rubber vulcanizate,
in the case of a polyester material, is a thermoplastic copolyester elastomer and/or a thermoplastic urethane elastomer, and
in the case of a polyamide material, is a thermoplastic polyamide elastomer and/or a thermoplastic copolyester elastomer and/or a thermoplastic urethane elastomer, and
extruding the data carrier recyclate in order to obtain a data carrier recycling foil.

26. The method according to claim 25, wherein a multilayer composite foil having an inner layer and at least two further layers is produced, in which at least the inner layer includes the data carrier recyclate, comprising the following steps:
feeding at least the extruder producing the inner layer with the data carrier recyclate or a material forming the data carrier recyclate,
feeding one or several further extruders with the data carrier recyclate or with a material forming a data carrier recyclate or with a plastic material that does not include recycled plastic material,
coextruding the inner layer and the at least two further layers and thereby producing a composite foil.

27. The method according to claim 25, wherein a composite foil having several layers which include the data carrier recyclate is produced, and
wherein in each layer which includes a data carrier recyclate the portion of recyclate is the higher the further inward in the layer composite of the composite foil the layer is located.

28. A data carrier comprising a card body which comprises at least one data carrier recycling foil according to claim 20.

29. The data carrier according to claim 28, further comprising at least one electronic module and/or an imprint.

30. The data carrier according to claim 28, wherein the data carrier is a SIM card, a credit card or an ID card.
